(19) United States
(12) Patent Application Publication
(10) Pub. No.: US 2004/0231018 A1
(43) Pub. Date: Nov. 18, 2004

(54) Escrow management structure

(76) Inventor: A. Wayne Olson, Las Vegas, NV (US)

Correspondence Address: Kit M. Stetina, Esq., STETINA BRUNDA GARRED & BRUCKER, Suite 250, 75 Enterprise, Aliso Viejo, CA, 92656, US

(21) Appl. No.: 10/777,344

(22) Filed: Feb. 12, 2004

Related U.S. Application Data
(63) Continuation of application No. 09/677,825, filed on Sep. 28, 2000.
Application No. 09/677,825 is a continuation-in-part of application No. 09/550,674, filed on Apr. 17, 2000, now abandoned.

(51) Int. Cl. G06F 17/00

(52) U.S. Cl. 902/23; 705/39

(57) ABSTRACT

A method of allowing a customer to place a wager on a gaming action with a merchant through an electronic transaction is disclosed. The method comprises establishing a deposit account for the customer with an escrow account provider. Next, the wager for the gaming action is placed with the merchant. The escrow account provider will then determine whether the wager is for casino action or sports book action. Funds for the wager will be transferred from the deposit account of customer to a prescribed account of the escrow account provider depending on the type of wager. Next, the merchant is notified that the funds for the wager have been transferred. The escrow account provider will then verify that the merchant can cover the wager and as such will transfer funds for the wager from the prescribed account to an action account during the pendency of the gaming action. Finally, the funds will be transferred to either the merchant or the customer, depending on whether the customer has won or lost the wager.

### CROSS-REFERENCE TO RELATED APPLICATIONS

The present application is a continuation-in-part of U.S. application Ser. No. 09/550,674 filed Apr. 17,2000, the disclosure of which is expressly incorporated herein by reference.

### STATEMENT RE: FEDERALLY SPONSORED RESEARCH/DEVELOPMENT

(Not Applicable)

### BACKGROUND OF THE INVENTION

The present invention generally relates to online purchases and more particularly to a method of verifying adequate funds for the purchase of products and services online.

Currently, online purchasing of goods and services has become popular. The Internet is being used as a commercial pathway for the purchase of products, content and electronic wagering. Many users of the Internet are purchasing products that are delivered directly to them.

Typically, in order to purchase an item over the Internet, the purchaser must give the Internet merchant his or her credit card information as the form of payment. In turn, the Internet merchant will charge the purchaser's credit card the amount of the purchase. Many purchasers do not desire to give out credit card information to online merchants due to the risk of fraudulent charges being placed on their card. Additionally, many purchasers are fearful of their credit card number being stolen while it is being transmitted over the Internet.

Additionally, purchasers of goods or services are worried that their purchase will be charged to their credit card without any goods being received. This can be especially true wherein online content is to be downloaded to the purchaser. Specifically, the purchaser will supply the Internet merchant his or her credit card number to download the desired content. Oftentimes, downloading of the content will be unexpectedly interrupted such that the purchaser will not receive the completed download. However, because the purchaser has already paid the full amount for the online content, there is a risk of an unscrupulous content provider not refunding the amount of the download or providing a new download. Similarly, for the purchase of a product, there is the chance that a merchant may not send the product to the customer even though the customer has already paid the merchant.

Online gaming and wagering permits Internet users to place bets from anywhere in the world. The user can place bets in sporting events and/or play online casino games. The user typically pays for these activities by providing his or her credit card number to the online casino or wagering service. However, as previously mentioned, Internet users are hesitant to provide credit card information to online merchants. Additionally, with online casinos and wagering, there is the added risk that the user will not be paid his winnings. There is no guarantee that the online casino or wagering service will have adequate funds to cover the user's bets. Therefore, the users of online casinos and wagering services must assume the risk of wagering.

In addition to the foregoing, online merchants must verify that the credit card information provided to them is correct and that the purchaser has enough credit to purchase the goods and/or services. Accordingly, the online merchant must verify the credit card information with the credit card provider. If the credit card has been recently stolen, the credit card provider may not have up-to-date information thereby approving the transaction with the stolen credit card. Additionally, there is the added risk that the purchaser may have exhausted all his available credit, but the credit card provider does not know this information yet such that the transaction may be approved. Accordingly, there is a need for a quick and simple system for verifying adequate funds for an online purchase.

The present invention addresses the above-mentioned deficiencies with online purchasing by providing a method whereby funds are verified before purchase of goods and services online. In this respect, the method of the present invention provides a system whereby online merchants can be assured that the purchaser has adequate funds for the online purchase. Additionally, the present invention provides for a system and method whereby the online merchant will not receive the funds for an online purchase until the purchaser has received delivery. Furthermore, the present invention provides for a system and method whereby it is first verified that the online casino can cover the wager before being placed with an online casino.

### BRIEF SUMMARY OF THE INVENTION

A method of allowing a custom er to purchase a product having a purchase price from a merchant through an electronic transaction. The method comprising the step of establishing a deposit account on behalf of the customer with an escrow account provider. Next, funds are transferred into the deposit account. The customer will then place an order with the merchant. The balance of the deposit account will be verified to confirm that the balance is at least equal to the purchase price of the product. Next, the merchant will be notified that the balance in the deposit account is at least equal to the purchase price such that the merchant will deliver the product to the customer. Finally, the purchase price of the product will be transferred from the deposit account to the merchant by the escrow account provider upon confirmation of delivery of the product to the customer.

In the preferred embodiment, the purchase price for the product will be transferred from the deposit account to a set aside account subsequent to verification that the balance is at least equal to the purchase price. Accordingly, the purchase price of the product will be transferred from the set aside account to the merchant upon confirmation of delivery of the product to the customer. The step of verifying that the deposit account balance is at least equal to the purchase price may be accomplished by the escrow account provider or by a financial institution if the customer does not have a deposit account established with the escrow account provider. If the customer does not have a deposit account with the escrow account provider then the purchase price of the product will be transferred from the financial institution to a temporary deposit account upon verification of sufficient funds.

Typically, in order to ensure receipt of the product by the customer, the escrow account provider will require a signature. Upon receipt of the signature, the escrow account provider will transfer the purchase price of the product to a settlement account which is then transferred to the merchant on a daily basis. The escrow account provider may withdraw a small fee from the purchase price of the product as a service charge.

In accordance with the present invention, there is provided a method of allowing a customer to purchase online content having a purchase price from a merchant through an electronic transaction. The method comprises the step of establishing a deposit account on behalf of the customer with an escrow account provider. Next, funds are transferred by the customer into the deposit account. The customer will then place an order with the merchant for the desired online content. The escrow account provider will then verify that the deposit account has a balance which is at least equal to the purchase price. The escrow account provider will notify the merchant that the balance in the deposit account is at least equal to the purchase price such that the merchant will download the online content to the customer. Finally, the escrow account provider will transfer the purchase price of the online content from the deposit account to the merchant upon confirmation of successful download.

In order to ensure the online content has been successfully downloaded, the merchant must agree to notify the escrow account provider upon confirmation of a successful transmittal of the online content. Accordingly, the escrow account provider will notify the customer of the successful download after notification by the escrow account provider. After the escrow account provider has notified the customer of the successful download, the purchase price of the online content will be transferred to the merchant.

In accordance with the present invention, there is provided a method of allowing a customer to place a wager on gaming action with a merchant through an electronic transaction. The method comprises establishing a deposit account for the customer with an escrow account provider. Next, the customer will place a wager for gaming action with the merchant. Funds for the wager will be transferred from the deposit account to a set-aside account. The merchant will be notified that the funds have been transferred to the set-aside account. The escrow account provider will verify that the merchant can cover the wager. If the bet is for a casino wager (i.e., card game), a casino cage of the present invention will handle all win/loss calculations for the casinos. However, if the wager is for a sports book (i.e., sporting event), then all action requests for the sports book action will be placed in a gaming post up account. During the pendency of the gaming action, the funds for the wager will be transferred from either the casino cage or the gaming post-up account to a set aside account. Finally, the funds for the wager will be transferred to either the merchant or the customer depending upon whether the customer has won or lost the wager.

If the customer wins the gaming action, then the funds will be transferred to the customer. However, if the customer loses the wager, then the funds will be transferred to the merchant. As mentioned above, the escrow account provider must verify that the merchant can cover the wager. If the merchant does not have sufficient funds to cover the wager, the escrow account provider will suspend play. Once the merchant has enough funds to cover the wager, play will be resumed.

### BRIEF DESCRIPTION OF THE DRAWINGS

These as well as other features of the present invention will become more apparent upon reference to the drawings wherein:

FIG. 1 is a diagram depicting an escrow management structure of the present invention;

FIG. 2 is a diagram depicting an account structure for the escrow management structure shown in FIG. 1;

FIG. 3 is a flowchart depicting the method of purchasing a product with the escrow management structure shown in FIG. 1;

FIG. 4 is a flowchart depicting the method of purchasing online content with the escrow management structure shown in FIG. 1; and

FIG. 5 is a flowchart depicting the method of purchasing gaming action with the escrow management structure shown in FIG. 1.

### DETAILED DESCRIPTION OF THE INVENTION

Referring now to the drawings wherein the showings are for purposes of illustrating a preferred embodiment of the present invention only, and not for purposes of limiting the same, FIG. I graphically illustrate an escrow management structure 10 used for the purchase of products, online content and gaming action over the Internet. The escrow management structure 10 is implemented by an escrow account provider on a network of computers that are capable of communicating with each other in order to transfer funds therebetween.

### SYSTEM OVERVIEW

A customer 12 contacts a merchant 14 for an online purchase. As used in this application, an online purchase refers to the purchase of goods, services, online content, or wagering via electronic means such as the Internet. A merchant 14 is the seller of the goods, services, online content or provider of online wagering. The customer 12 typically contacts the merchant 14 via the merchant's web site. The web site of the merchant is typically hosted through a series of merchant computers 16. The merchant computers 16 access the Internet 18 to contact an escrow account server 20 of the escrow management structure 10. Specifically, the merchant computers 16 first contact the Server POS/Firewall 22 over the Internet 18 which in turn contacts the escrow account server 20 through a dedicated, secure connection. Once the escrow account server 20 has been contacted, a secure dedicated connection 24 is established between the merchant computers 16 and the escrow account server 20. In addition to the foregoing, the server POS/Firewall 22 is in communication with a gateway 26 that transmits accept/decline information to and from financial institutions such as banks.

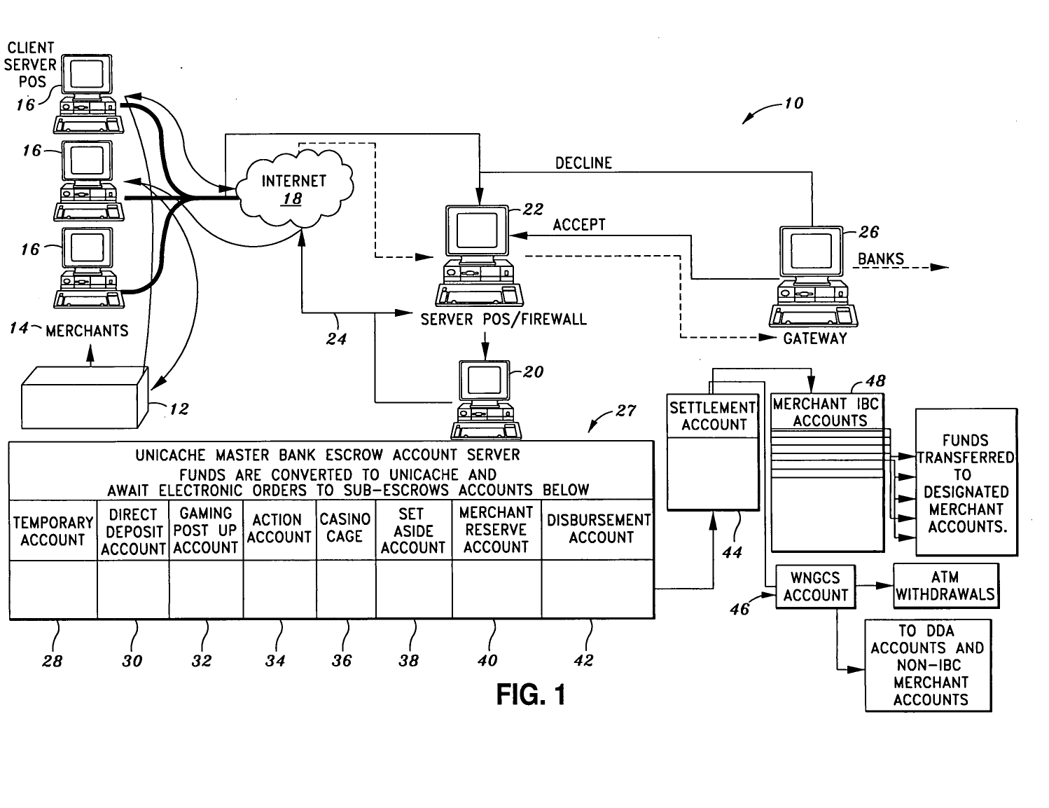

As seen in FIG. 1, the escrow account server 20 is configured with electronic accounts 27 used for purchasing goods and services. In this respect, the escrow account server 20 maintains data regarding a temporary account 28, a direct deposit account (DDA) 30, a gaming post-up account (GPA) 32, an action account (AA) 34, a casino cage (CC) 36, a set aside account (SAA) 38, a merchant gaming post-up account (MGPA) 40, and a disbursement account (DA) 42. The electronic accounts 27 are used for transferring funds between the customer 12 and the merchant 14, as will be explained below.

In addition to the electronic accounts 27, the escrow account server 22 further includes a settlement account (SA) 44 for disbursement of funds to the accounts of the merchant 14 through merchant international business companies (IBC) accounts 48. Furthermore, the escrow account server 22 maintains a world net global commerce system (WNGCS) account 46 for distribution of funds to non-IBC merchant accounts.

### ACCOUNTS OVERVIEW

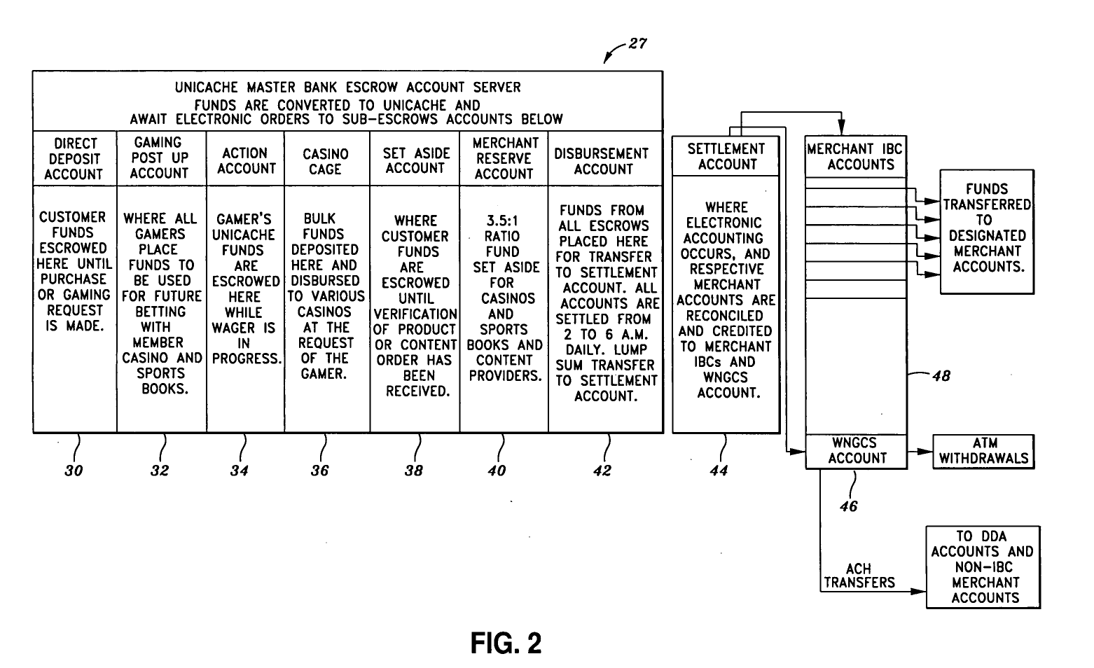

Referring to FIG. 2, the accounts 27 are sub-escrow accounts which monitor and maintain funds. The direct deposit account 30 is the location whereat a customer's money is held until a purchase or gaming request is made. Funds are placed within the direct deposit account 30 by the customer 12 through direct withdrawal from the customer's bank account or through a credit card transfer. The temporary account 28 is similar to the direct deposit account 30, however it is used for depositing funds by a non-account holder customer 12.

The gaming post-up account 32 is the location whereby a customer 12 engaged in online gambling can temporarily place funds for future betting with a sports book. The action account 34 is the account where funds are placed while a wager for online gaming is in progress. In this respect, during a wager that was purchased through an online transaction, the funds for the wager are placed within the action account 34 during the pendency of gaming action. The casino cage 36 is an account that the customer 12 can deposit funds into such that the funds will be disbursed to various casinos (i.e., merchants 14) at the request of the customer 12. Additionally, the casino cage 36 is used for wagers placed for online casino action.

The set aside account 38 is an account that funds from the direct deposit account 30 are transferred into during the purchase of a product or online content. Specifically, customer's funds are escrowed within the set aside account 38 until verification of delivery of the product or online content has been received by the escrow management structure 10.

The merchant gaming post-up account 40 is the account whereby the online casino or sports book maintains adequate funds to cover wagers by the customers 12. In this respect, the merchant gaming post-up account 40 must maintain adequate funds to cover the wagers made by customers 12. Winnings to the customers 12 are disbursed from the merchant gaming post-up account 40, while losses of the customers 12 may be transferred thereinto also.

The disbursement account 42 is the account that all escrowed funds are. transferred into for final disbursement to merchants 14. Funds from the disbursement account 42 are transferred regularly (i.e., daily at 2:00 am) in a lump sum to the settlement account 44. The settlement account 44 performs electronic accounting such that respective merchant accounts are reconciled and credited to merchant IBC accounts 48 and WNGCS account 46. Additionally, fees for using the escrow management structure 10 are withdrawn from the settlement account 44 prior to disbursement to the merchant's accounts.

### PRODUCT PURCHASE

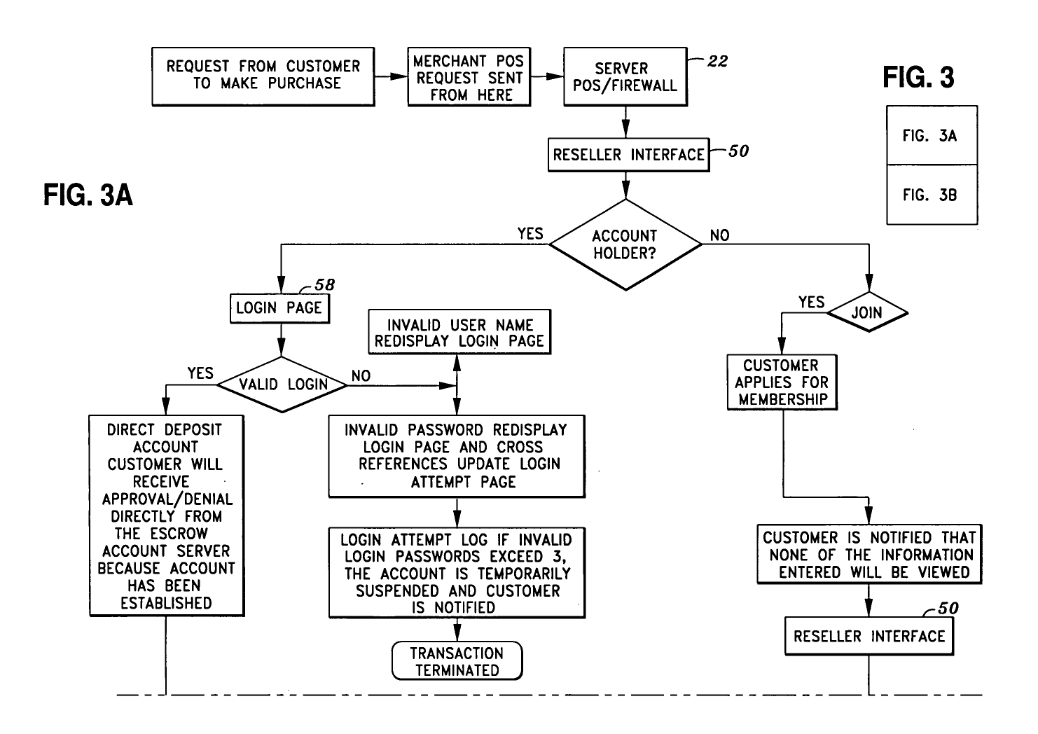

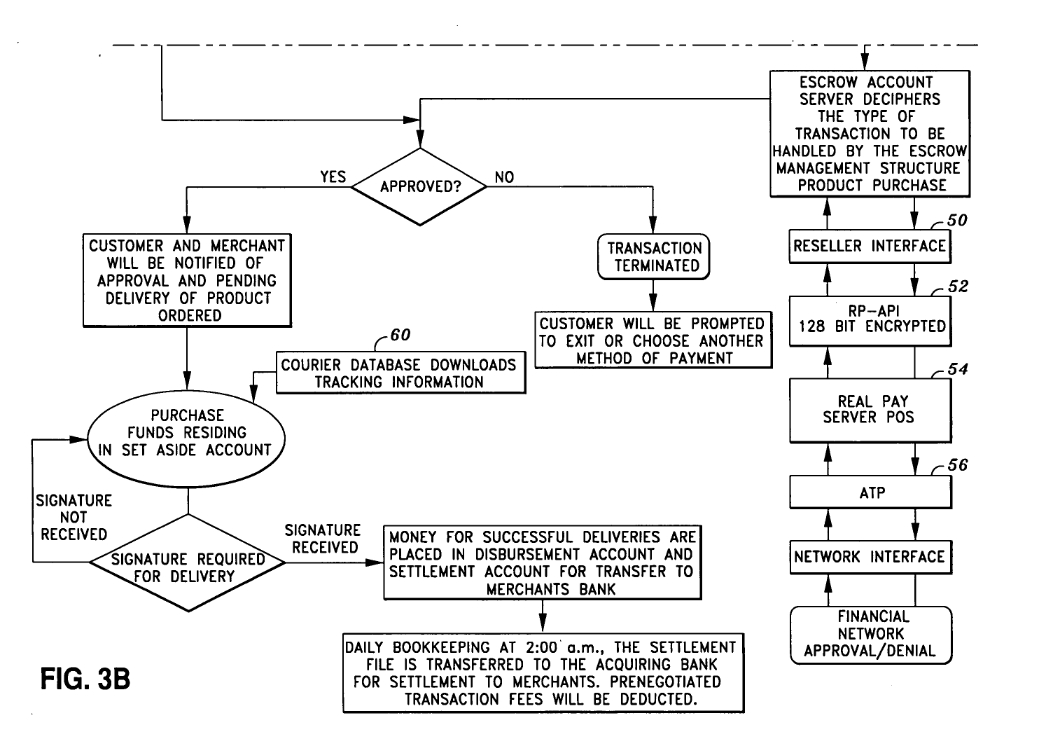

In accordance with the present invention, there is provided a method of verifying funds for the purchase of a product over the Internet. Referring to FIG. 3, a customer 12 makes a request for a product to the merchant's POS computers 16. The request is directed to the escrow account server 20 for processing by the escrow management structure 10. A reseller interface 50, programmable on the server POS/firewall 22, functions as a liaison between the merchant computers 16 and the escrow account server 20. The server POS/firewall 22 is operative to determine the customer and relay such information the reseller interface 50. The reseller interface 50 determines whether the customer is an account holder of the escrow management structure 10. An account holder is a customer 12 who has already registered with the escrow management structure 10 such that account information has already been configured. Additionally, an account holder will have funded his or her direct deposit account 30.

If the customer 12 is not an account holder, then the escrow management structure will inquire whether the customer wishes to join. If the customer 12 wishes to join, then the customer 12 will fill out a membership application and be notified that for security reasons none of the information entered will be viewed by the merchant 14 or by the manager of the escrow management structure 10. The customer 12 will then be able to access the escrow management structure 10 as an account holder, as will be explained below.

For new account holders, credit card or bank transfer information will be sent via the server POS/firewall 22 and gateway 26 to financial institutions for approval of the purchase. The purchase will be handled through the real pay-application programming interface (RP-API) 52, real pay server POS 54, and advanced transaction processor (ATP) 56 in order to either approve or deny the product purchase transaction with the appropriate financial institution. If the purchase is approved, the funds for the purchase will be transferred to the escrow management structure 10 and placed in the set aside account 38. The approval for the purchase will not be through the escrow account server 20 but by the financial institution. The approval or denial process may not be instantaneous because the financial institution must be contacted.

If the customer 12 is an existing account holder, then the customer 12 will be directed to a login page 58 and asked to enter a valid password and user name. If the user name or password is not valid, then the login page 58 will be displayed again. The customer will be given three opportunities to enter a valid password before the transaction is terminated and the customer with the entered user name is notified.

After a valid login, the customer 12, who is an existing account holder, will receive an immediate notification of approval or denial of the purchase because the customer 12 will have funds in their direct deposit account 30. Specifically, the customer 12 will have previously funded his or her direct deposit account 30 prior to making a purchase online. As previously mentioned, the direct deposit account 30 may be funded through credit card transfers or direct withdrawals from the customer's bank account. The approval or denial of the purchase will be immediate because the funds will be in the customer's direct deposit account 30 such that verification will be easily accomplished by accessing the balance of the customer's direct deposit account 30. Additionally, the approval or denial will be secure because it is being processed directly by the escrow account server 20.

If the transaction is not approved because the customer 12 does not have adequate funds in his or her direct deposit account 30, or is not approved by the customer's financial institution (i.e., nonexisting account holders), the transaction will be terminated. The customer 12 will be prompted to exit, or given the option of choosing another method of payment or funding his/her deposit account 30.

If the transaction is approved, both the customer 12 and the merchant 14 will be notified. The merchant 14 will ship the product to the customer 12 and notify the escrow account server 20 of the shipping method. Simultaneously, the funds used to purchase the product will be transferred from the customer's direct deposit account 30 to the set aside account 38. The funds for purchase of the product will not be released to the merchant 14 until notification of the delivery of the product has been received. Accordingly, a courier database 60 downloads tracking information to the escrow account server 20. The courier database 60 includes delivery information for the shipping method of the product and whether the product has been received by the customer 12.

If a signature for delivery of the product has not been received, the funds for the product will not be released to the merchant 14. On the other hand, if a signature has been received, the purchase funds will be immediately transferred to the disbursement account 42 and then to the settlement account 44 in a lump sum transfer. The settlement account 44 will be disbursed on a daily basis to the merchant's IBC account 48 or WNGCS account 46 as payment for the product. Furthermore, a small fee will be deducted from the settlement account 44 by the escrow account provider as a service charge.

As mentioned above, the merchant 14 will only receive payment if the product is successfully delivered to the customer 12. Accordingly, the customer 12 is protected by ensuring that delivery of the product occurs before the merchant 14 is paid. Similarly, because the funds for purchase are obtained prior to delivery of the product, but set aside until delivery, the merchant 14 is protected from fraudulent credit card transactions. Accordingly, the escrow management structure 10 of the present invention provides for product purchases that are both secure for the customer 12 and the merchant 14.

### CONTENT PURCHASE

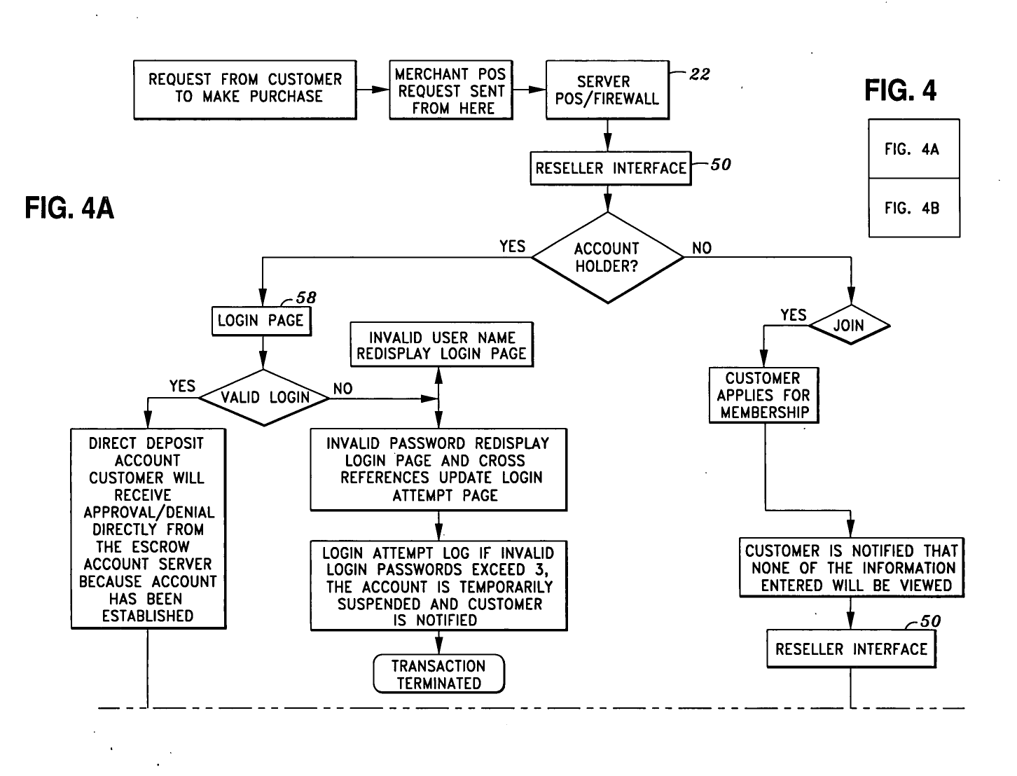

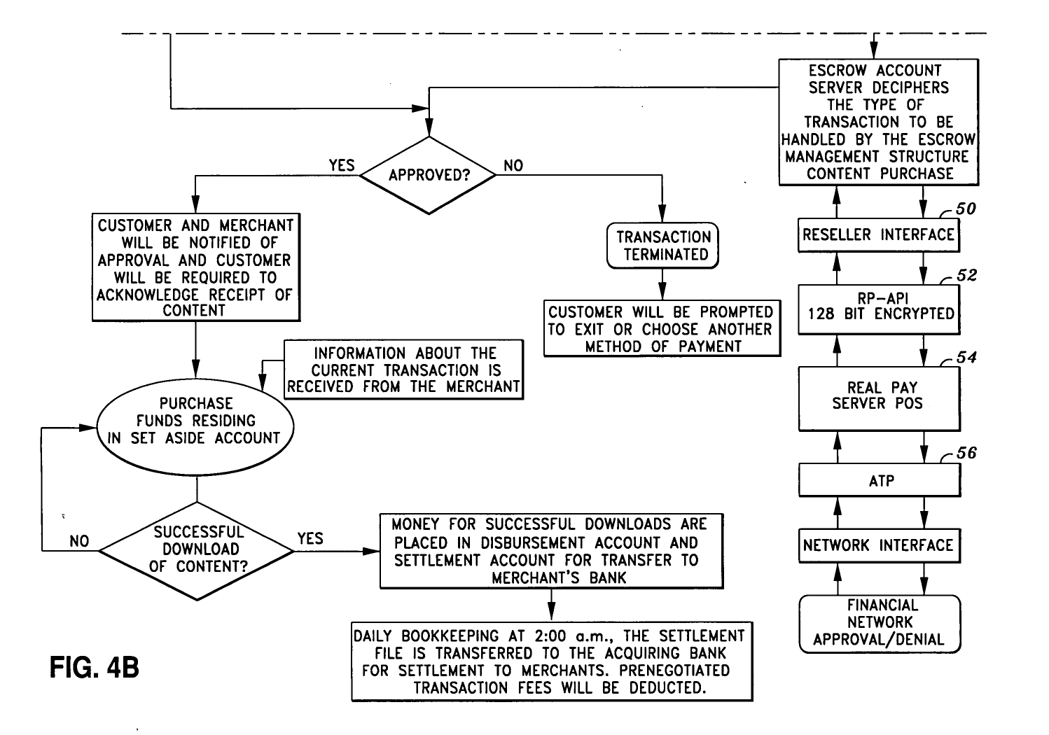

Referring to FIG. 4, a method of purchasing online content with the escrow management structure 10 is shown. Often times, the customer 12 may wish to purchase content such as online entertainment over the Internet. The content is downloaded or subscribed to the computer of the customer 12 for viewing thereby. As previously mentioned, a problem arises when the customer 12 has paid for the content, but has not received it due to an error during download. The escrow management structure 10 provides for a method of ensuring delivery of online content to the customer 12.

The method of ensuring payment for online content is similar to the method of payment for a product, as previously discussed. The customer 12 contacts the merchant 14 who contacts the server POS/firewall 22. The server POS/firewall 22 determines whether the customer 12 is an account holder. If the customer 12 is not an existing account holder, the customer 12 may join and purchase the online content using his or her credit card and the RP-API 52, as previously discussed.

If the customer 12 is an existing account holder, then the customer 12 will be prompted to enter a valid username and password in order to purchase the online content. Once the customer 12 is logged into the escrow management structure 10, the customer 12 and the merchant 14 will receive immediate approval or denial for the purchase based upon the balance of funds in the direct deposit account 30 of the customer 12. If the customer 12 does not have sufficient funds in his or her direct deposit account 30, then the transaction will be terminated and the customer 12 will be given the option of paying with another method.

If the purchase is approved, then the merchant 14 and the customer 12 will be notified. The merchant 14 will be required to notify the escrow account server 20 of a successful download or subscription. The merchant 14 will begin downloading the content to the customer 12 while funds are transferred from the direct deposit account 30 of the customer 12 to the set aside account 38. The purchase funds for the content will be maintained within the set aside account 38 until the escrow account server 20 receives verification of a successful download of content. The merchant 14 will provide the escrow account server 20 information regarding the username of the customer 12, as well as the type of content chosen for download. The merchant 14 will inform the escrow account server 20 of a successful download. Accordingly, the escrow account server 20 will notify the customer 12 of the successful download and transfer the purchase funds for the content or subscription to the merchant 14 via the disbursement account 42 and settlement account 44, as previously described above.

If the content was not successfully downloaded, then the purchase funds in the set aside account 38 will not be released until notification of a proper download. The content may not be successfully downloaded due to the cancellation by the customer 12, error of the merchant computers 14, and/or system failure. As such, if the content is not successfully delivered to the customer 12, the merchant 14 will not be paid for the content.

### GAMING ACTION PURCHASE

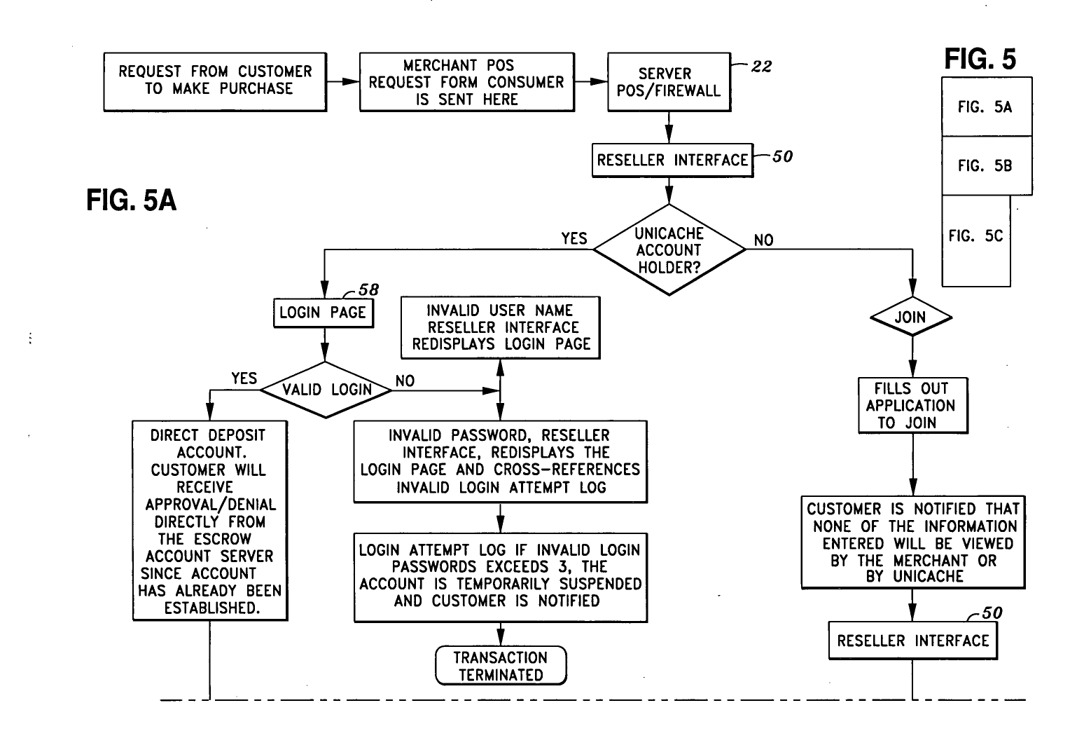

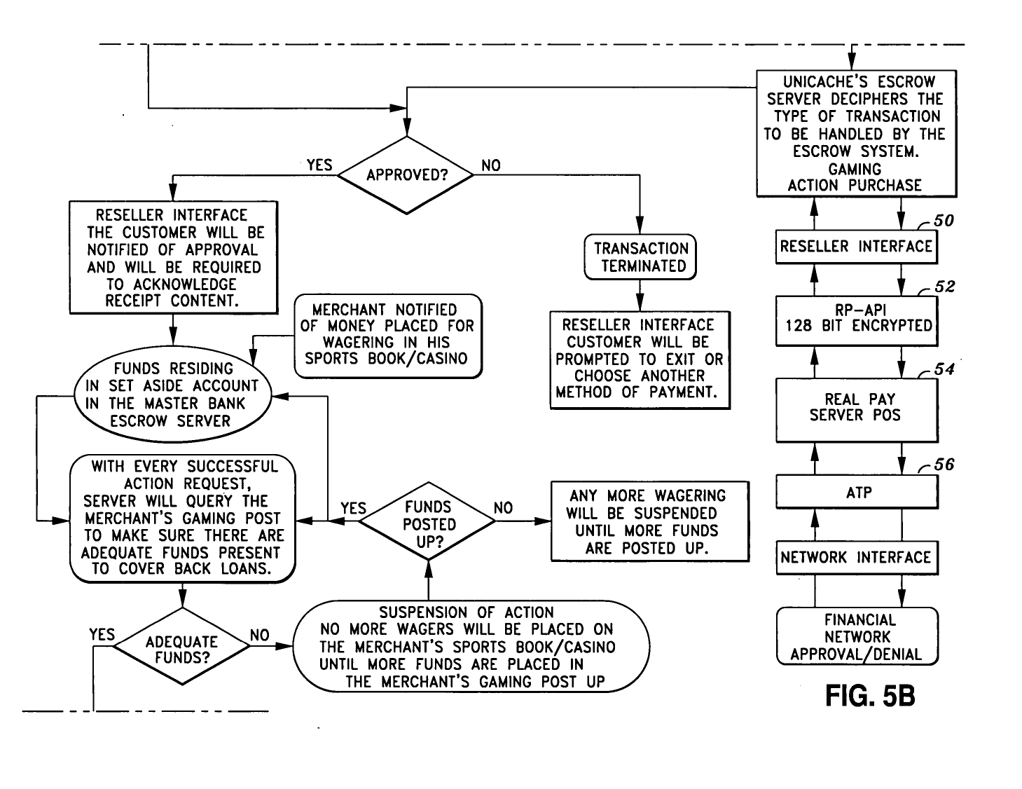

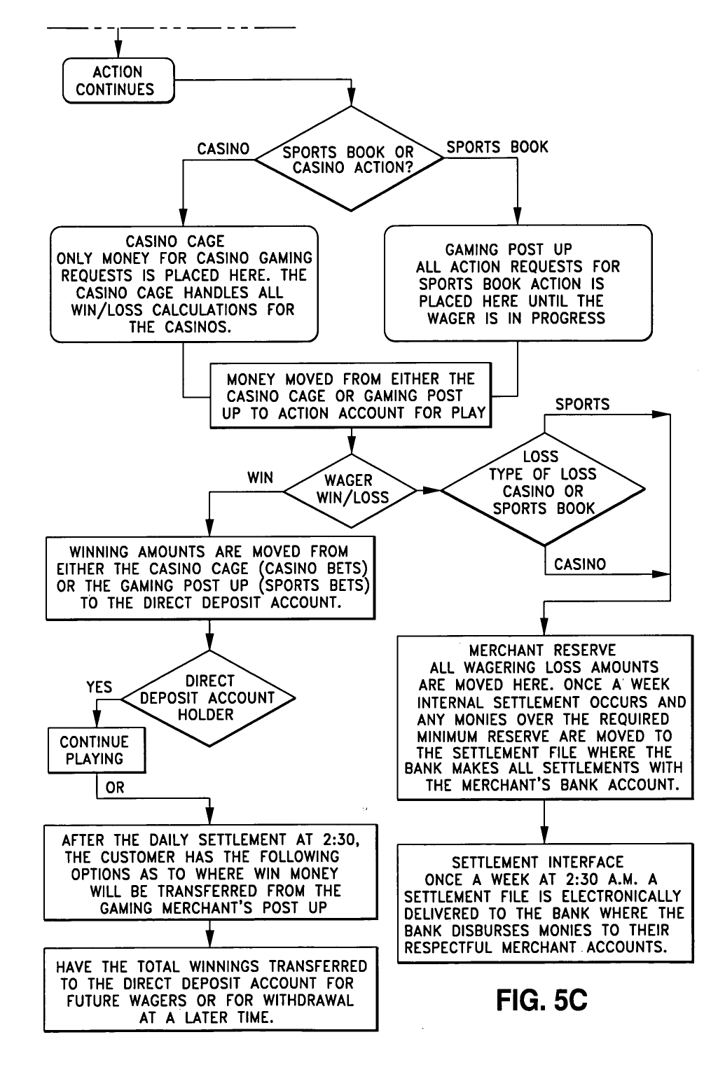

Referring to FIG. 5, a method of paying for online electronic wagering is shown. As mentioned above, a customer 12 may wish to place a wager with an online sports book/casino, but is fearful that the sports book/casino (i.e., merchant 14) will not have the adequate funds to cover the wager. The escrow account structure 10 provides a system whereby a merchant 14 must have sufficient funds to cover liabilities before gaming will commence. Additionally, the escrow account structure 10 provides a system whereby the customer 12 must post funds for the wager before gaming will commence. Accordingly, the escrow account structure 10 provides a system whereby both the merchant 14 (i.e., online sports book/casino) and customer 12 must post up funds to cover liabilities prior to gaming action.

The method of purchasing gaming action commences with the customer 12 contacting the merchant 14 who operates either an online sports book and/or casino. As used herein, an online sports book is used for placing wagers on sporting events such as horse racing, football games, baseball games, etc. An online casino provides online games of chance such as card games. The customer 12 places his wager with the merchant 14 who in turn contacts the server POS/firewall 22 for approval of the customer's transaction. At this point, the escrow account server 20 will determine if the customer 12 is an account holder. If the customer 12 is not an account holder, the escrow account server 20 will require the customer 12 to open an account and will approve the gaming purchase using the RP-API 52 method, as previously mentioned above.

If the customer 12 is an existing account holder, the customer 12 will receive immediate approval/denial based upon the balance of funds in his/her direct deposit account 30. If the customer 12 is not approved either through the RP-API 52 system or the direct deposit account 30, the transaction will be terminated and the customer 12 will be given the option to choose another method of payment or funding his/her direct deposit account 30. In this respect, the gaming transaction will not occur if the customer 12 does not have sufficient funds to cover a loss.

If the customer 12 is approved, the customer 12 and merchant 14 will be notified. Simultaneously, the gaming funds of the customer 12 for the wager will be placed in the set aside account 38. The merchant 14 will be notified that gaming funds of the customer 12 have been transferred into the set aside account 38 so that gaming may take place. Additionally, the escrow account server 20 will verify the funds in the merchant gaming post up account 40 of merchant 14 to determine whether the balance of funds can cover the wager in the event of a win by the customer 12. Specifically, the escrow account server 20 will query the merchant gaming post up account 40 to determine whether a sufficient balance exists to cover the liabilities of the sports book/casino. For example, the sports book/casino must maintain a prescribed ratio of funds that can be distributed to winners. Specifically, in the preferred embodiment, the ratio is 3.5:1 such that the sports book/casino must maintain 3.5 times the amount being wagered by the customers 12.

If the merchant 14 does not maintain the prescribed amount of funds in the gaming post-up account 40, then the gaming action will not be approved. Specifically, the gaming action will be suspended and no more wagers will be placed with the sports book/casino (i.e., merchant 14) using the escrow management structure 10 until sufficient funds are placed in the gaming post-up account 40 of the merchant 14. Once sufficient funds are transferred to the gaming post-up account 40, then wagering with the online sports book/casino may continue.

Next, the escrow account server 20 will determine whether the gaming action is a sports book or casino action. If the gaming action is for an online casino, then the casino cage 36 will handle all win/loss transactions. However, if the gaming action is for a sports book, then all action requests will be placed in the gaming post up account 32. As such, the casino cage 36 and the gaming post-up account 32 provide a separation of functions and accounts for the escrow management structure 10.

During play, the gaming funds of the customer 12 are transferred from the casino cage 36 or the gaming post up account 32 to the action account 34 depending on the type of wager. The gaming funds are maintained within the action account 34 during the pendency of the gaming action. For example, if the customer 12 has wagered on an athletic event, the gaming funds of the customer 12 will be maintained within the action account 34 during the athletic event.

After the gaming action has concluded, the customer 12 has either won or lost on his or her wager. If the customer 12 has lost, then the funds for the wager will be moved from the action account 34 to the disbursement account 42 for final settling and then transferred to the settlement account 44 for final accounting. The funds will then be transferred to the merchant 14, as previously discussed above. Additionally, the escrow account provider will withdraw a small fee from the settlement account 44 as a service charge.

If the customer 12 has won, then the winnings are moved from either the casino cage 36 or post up account 32 to the direct deposit account 30 of the customer 12. The customer 12 will be given the option to continue playing with his or her winnings, such that the winnings are credited to the customer 12. Otherwise, the customer 12 will be given the option of where to transfer his or her winnings. After gaming, the customer 12 can transfer the winnings to his or her direct deposit account 30 for future wagering or withdrawal at a later time.

As seen above, the escrow management structure 10 provides a system whereby both the merchant 14 and the customer 12 are protected during transactions. Specifically, the customer 12 is protected because the merchant 14 will not be paid until delivery to the customer is achieved. Accordingly, the merchant 14 will ensure that delivery is completed to the customer. Similarly, the merchant 14 is protected because funds for the purchase will be held in the escrow management structure I 0 prior to delivery. Accordingly, the merchant 14 will be guaranteed payment. Therefore, the escrow management structure 10 provides a system and method for providing safe and secure online transactions for both the merchant 14 and the customer 12.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A method of allowing a customer to place a wager on gaming action with a merchant through an electronic transaction, the method comprising the steps:
a) establishing a deposit account for the customer with an escrow account provider;
b) placing the wager for the gaming action with the merchant;
c) determining the type of wager;
d) transferring funds for the wager from the deposit account to a prescribed account depending on the type of wager;
e) notifying the merchant that the funds for the wager have been transferred;
f) verifying the merchant can cover the wager;
g) transferring the funds for the wager from the prescribed account to an action account during pendency of the gaming action; and
h) transferring funds for the wager from the action account to one of the merchant and the customer.

2. The method of claim 1 wherein the completion of the gaming action will result in one of a win and a loss, and step (h) comprises transferring funds to the customer for a win and transferring funds to the merchant for a loss.

3. The method of claim 1 wherein step (f) further comprises suspending play if the merchant does not have sufficient funds to cover the wager.

4. The method of claim 3 wherein step (f) further comprises resuming play when the merchant has funds to cover the wager.

5. The method of claim 1 wherein the merchant has a gaming post up account and step (f) comprises verifying the merchant can cover the wager with the funds in the gaming post-up account.

6. The method of claim 1 wherein the wager may be for either a sports book or a casino and step (c) comprises determining whether the wager is for the sports book or the casino.

7. The method of claim 6 wherein step (d) further comprises transferring funds to a casino cage for a casino action or transferring the funds to a gaming post up account for a sports book action.
